(19) United States
(12) Patent Application Publication
(10) Pub. No.: US 2020/0338706 A1
(43) Pub. Date: Oct. 29, 2020

(54) Fastener Extraction Tool

(71) Applicants: Robert Thomas Brent Cunningham, San Diego, CA (US); Thomas J. Underwood, San Diego, CA (US)

(72) Inventors: Robert Thomas Brent Cunningham, San Diego, CA (US); Thomas J. Underwood, San Diego, CA (US)

(73) Assignee: Mockit Science, LLC, Sandy, UT (US)

(21) Appl. No.: 16/395,162

(22) Filed: Apr. 25, 2019

(51) Int. Cl. B25B 27/18

(52) U.S. Cl. CPC B25B 27/18

(57) ABSTRACT

An extraction tool for the removal of fasteners with stripped heads. A method of extracting fasteners with stripped heads.

The present application claims priority to the earlier filed provisional application having Ser. No. 62/664,042, and hereby incorporates subject matter of the provisional application in its entirety

### FIELD

The present disclosure relates generally to a tool for assisting in the extraction of fasteners, more especially fasteners with stripped or deformed heads.

### BACKGROUND

This disclosure relates to an apparatus and a method for a fastener extraction tool. Specifically, this relates to a device placed between a driver and the fastener.

Typical fastener extraction tools require the use of specialty driver bits. This problem can limit the application and usefulness of these types of extraction tools by requiring the user to change the bit driver. Transitioning from one driver to another specialty driver requires two separate actions: removing the current driver, then installing the specialty driver. In addition, it may require a specific size of specialty driver to match the fastener size.

### SUMMARY

One aspect provided herewith is a fastener extraction tool that allows the user to keep the current driver installed. The tool comprises a main flexible body; one or more laminate layers of adhesive; one or more removable backing layers; and a housing component that stores the tool or multiple tools when not in use.

Also provided is a method of extracting a fastener, especially a fastener with a stripped head. The method comprises using the tool placed with the adhesive side on the fastener head and using a typical driver to remove the fastener.

Also provided is a method for storing, removal for use, and return for storage of the tool to its housing component.

### BRIEF DESCRIPTION OF THE DRAWINGS

FIG. 1 is an isometric view of a set of fastener extraction tools with two backing layers and two adhesive layers.

FIG. 2 is an isometric view of a set of fastener extraction tools with one backing layer and one adhesive layer.

FIG. 3 is a perspective top view of the set of fastener extraction tools of FIG. 1 with two backing layers and two adhesive layers.

FIG. 4 is a perspective top view of the set of fastener extraction tools of FIG. 2 with one backing layer and one adhesive layer.

FIG. 5 is a cross-sectional view of the set of fastener extraction tools of FIG. 1, taken along line 5-5 in FIG. 3, with two backing layers and two adhesive layers.

FIG. 6 is a detail cross-sectional view of the set of fastener extraction tools of FIG. 1, taken from inside the dashed line 6 of FIG. 5, with two backing layers and two adhesive layers.

FIG. 7 is a cross-sectional view of the set of fastener extraction tools of FIG. 2, taken along line 7-7 in FIG. 4, with one backing layer and one adhesive layer.

FIG. 8 is a detail cross-sectional view of the set of fastener extraction tools of FIG. 2, taken from inside the dashed line 8 of FIG. 7, with one backing layer and one adhesive layer.

FIG. 9 is an isometric view of a single fastener extraction tool with one layer of adhesive.

FIG. 10 is a perspective top view of the single fastener extraction tool with one layer of adhesive as shown in FIG. 9.

FIG. 11 is a perspective side view of the single fastener extraction tool with one layer of adhesive as shown in FIG. 9.

FIG. 12 is an isometric view of a single fastener extraction tool.

FIG. 13 is a perspective top view of the single fastener extraction tool as shown in FIG. 12.

FIG. 14 is a perspective side view of the single fastener extraction tool as shown in FIG. 12.

FIG. 15 is a isometric view of the single fastener extraction tool with one layer of adhesive as shown in FIG. 9, a typical driver bit, and a typical fastener screw.

FIG. 16 is a isometric view of the single fastener extraction tool with one layer of adhesive as shown in FIG. 9, a typical driver bit, and a typical fastener screw. The single fastener extraction tool with one layer of adhesive attached to the typical fastener screw.

FIG. 17 is a isometric view of the single fastener extraction tool with one layer of adhesive as shown in FIG. 9, a typical driver bit, and a typical fastener screw. The single fastener extraction tool with one layer of adhesive attached to the typical fastener screw. The typical driver bit engaged with the single fastener extraction tool.

FIG. 18 is a perspective side view of the single fastener extraction tool with one layer of adhesive as shown in FIG. 9, a typical driver bit, and a typical fastener screw.

FIG. 19 is a perspective side view of the single fastener extraction tool with one layer of adhesive as shown in FIG. 9, a typical driver bit, and a typical fastener screw. The single fastener extraction tool with one layer of adhesive attached to the typical fastener screw. The typical driver bit engaged with the single fastener extraction tool.

While the devices and methods described herein are susceptible to various modifications and alternative constructions, certain illustrative embodiments have been shown in the drawings and will be described below in detail. It should be understood, however, that there is no intention to limit the disclosure to the specific embodiments disclosed. On the contrary, the intention is to cover all modifications, alternative constructions, and equivalents falling within the spirit and scope of the disclosure.

### DETAILED DESCRIPTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

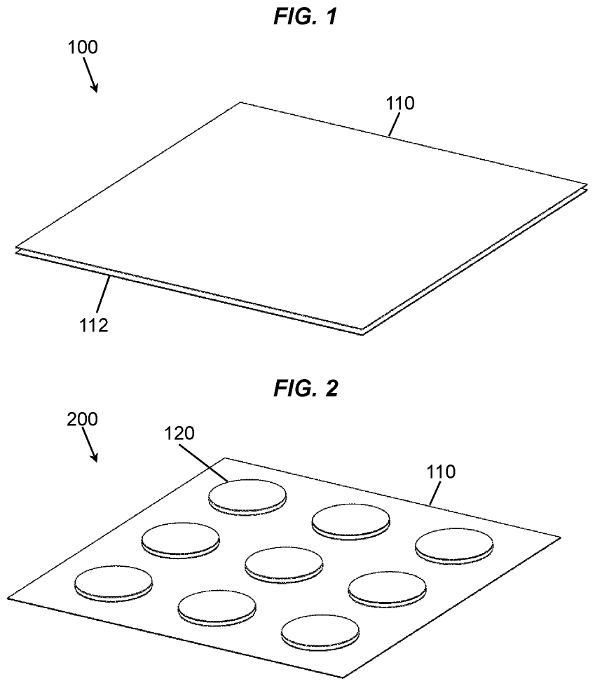

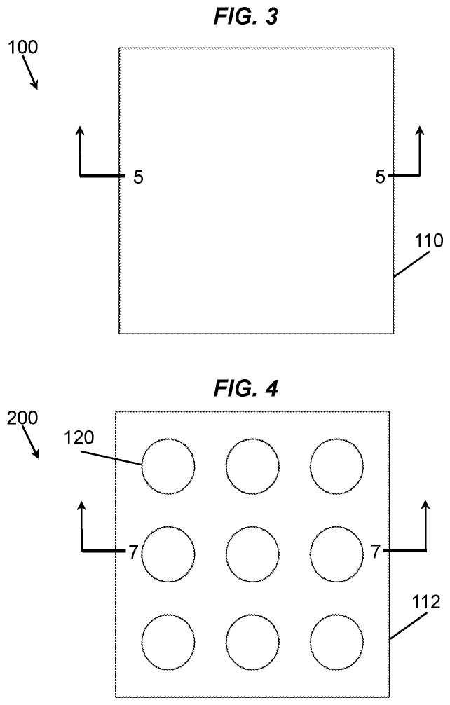

Referring now to FIGS. 1 and 3 of the drawings, a set of fastener extraction tool or tools 100 with a first backing layer 110 and a second backing layer 112 is shown. The backing layers 110 and 112 protect and cover the set of fastener extraction tool or tools 100.

Referring now to FIGS. 2 and 4, of the drawings, a set of fastener extraction tool or tools 200 with one backing layer 112 is shown. The backing layer 112 protects and covers the set of elastomer layers 120.

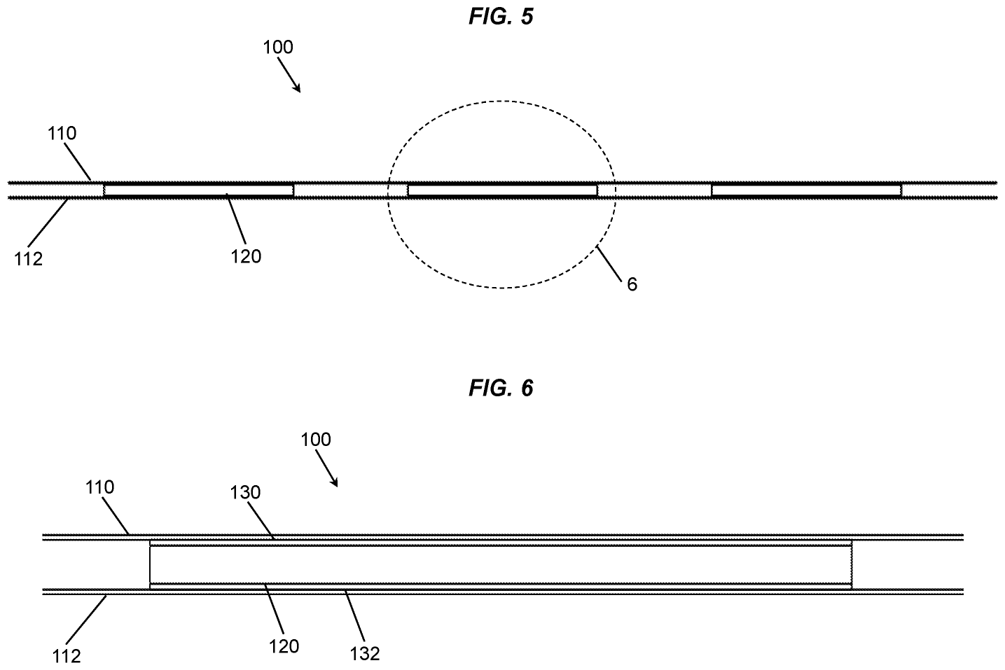

Referring now to FIGS. 5 and 6, section views 5-5 from FIG. 3 a side view of the set of fastener extraction tools 100 is shown with the backing layers 110 and 112 sandwiching a typical elastomer layer 120. FIG. 6 depicts the detail of Area 6 shown in FIG. 5 of the set of fastener extraction tools 100 with backing layers 110 and 112 sandwiching a typical elastomer layer 120 and adhesive layers 130 and 132. The adhesive layers 130 and 132 are securely attached to the elastomer layer 120. The adhesive layers 130 and 132 are lightly attached to the backing layers 110 and 112 respectively.

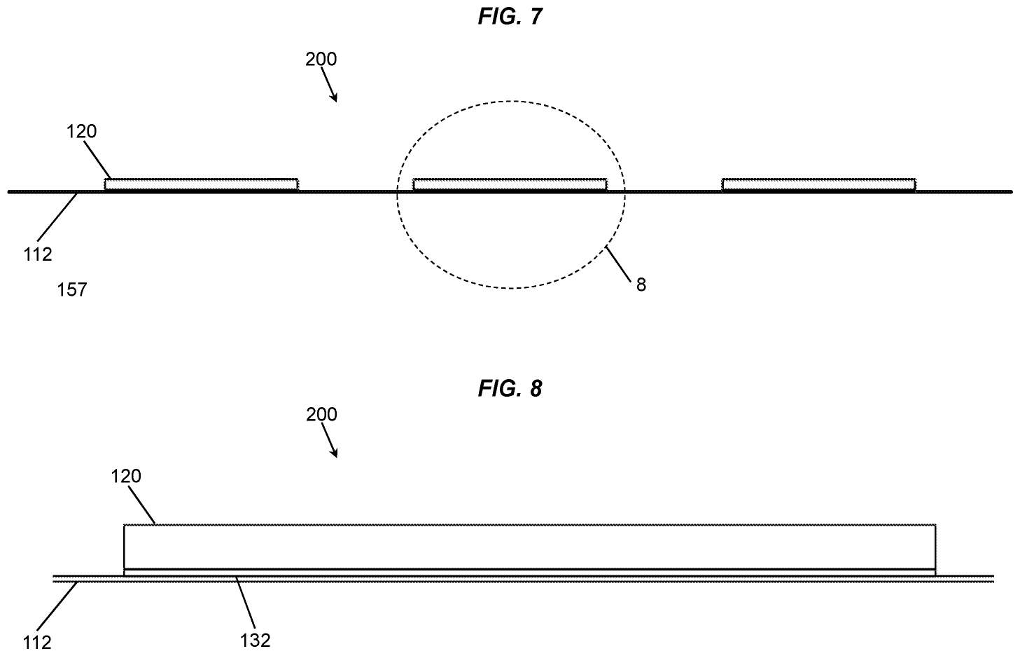

Referring now to FIGS. 7 and 8, section views 7-7 from FIG. 4 a side view of the set of fastener extraction tools 200 is shown with the backing layer 112 and a typical elastomer layer 120. FIG. 8 depicts the detail of area 8 shown in FIG. 7 of the set of fastener extraction tools 200 with backing layer 112 sandwiching a typical elastomer layer 120 and adhesive layer 132. The adhesive layer 132 is securely attached to the elastomer layer 120. The adhesive layer 132 is lightly attached to the backing layer 112.

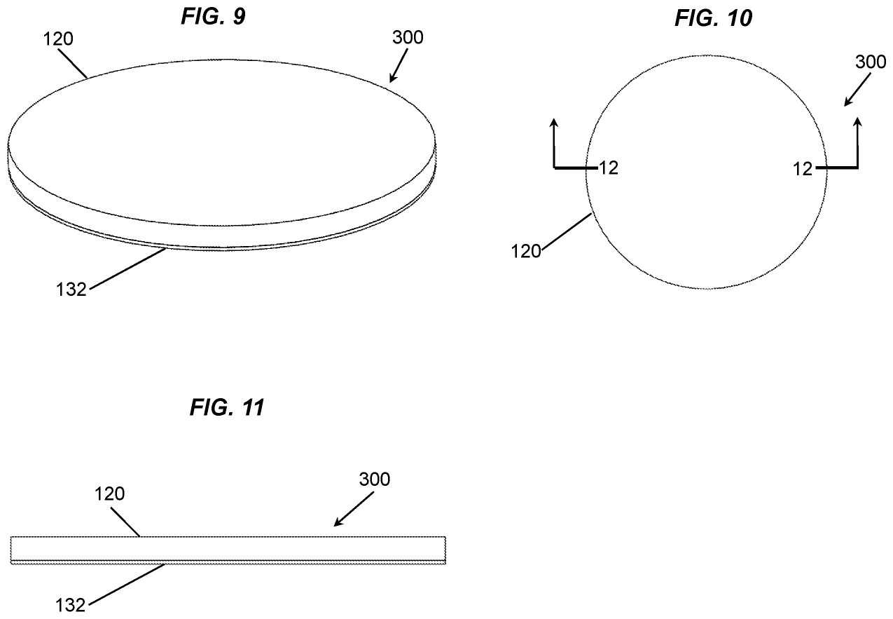

Referring now to FIGS. 9, 10, and 11 of the drawings, isometric, top, and cross-section views of the fastener extraction tool 300 with the elastomer layer 120 and adhesive layer 132 are shown. The adhesive layer 132 is securely attached to the elastomer layer 120.

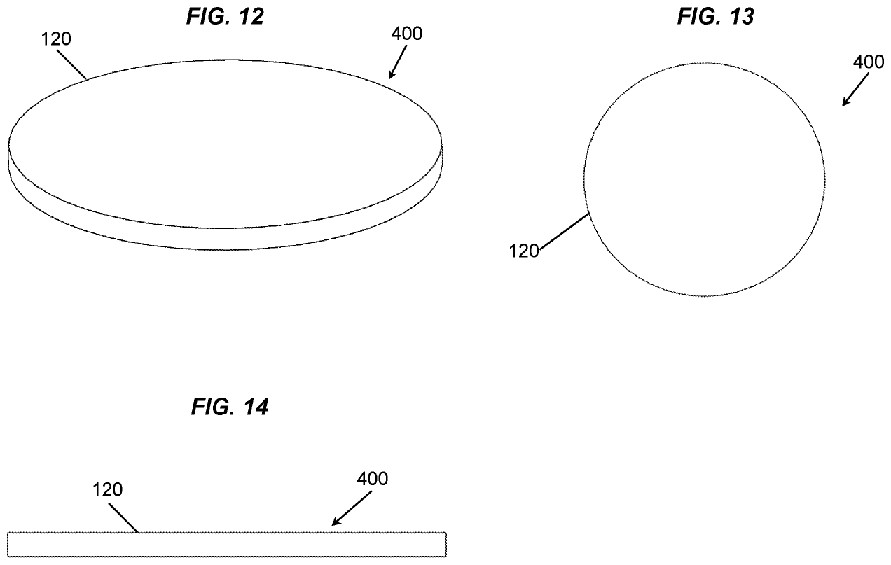

Referring now to FIGS. 12, 13, and 14 of the drawings, isometric, top, and cross-section views of the fastener extraction tool 400 with the elastomer layer 120 are shown.

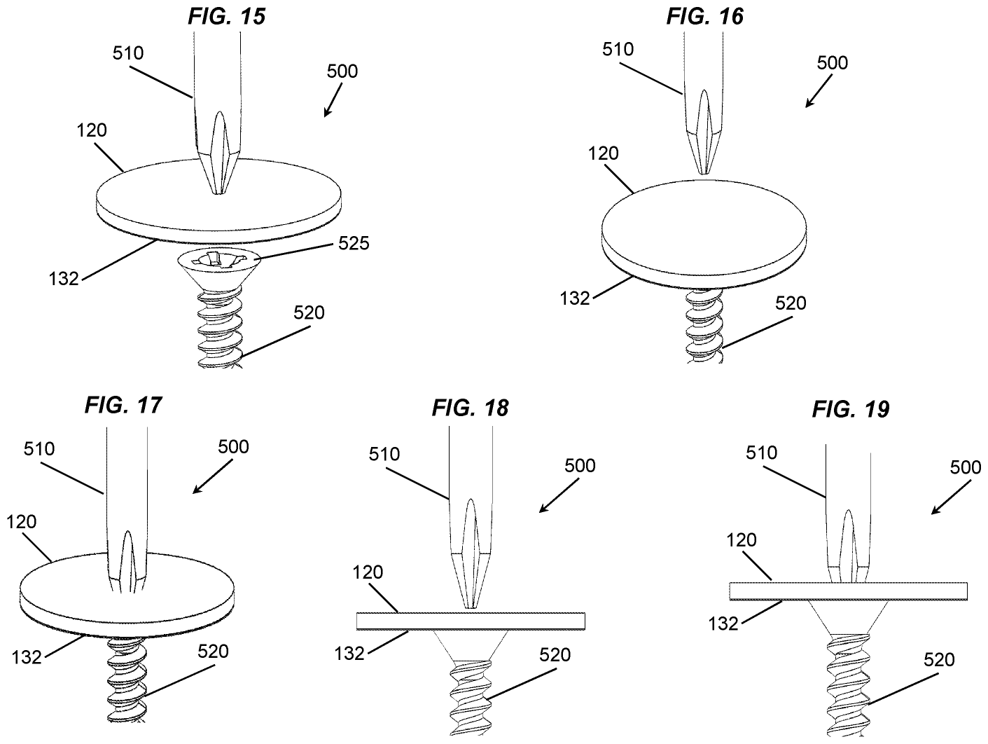

Referring now to FIGS. 15, 16, 17, 18, and 19 of the drawings isometric and top views of an example typical use assembly 500 is shown. A typical bit driver 510 and a typical fastener screw 520 are shown. FIGS. 17 and 19 include the assembly 500 where the typical bit driver 510 is engaged into the elastomer layer 120 and the adhesive layer 132 is attached to the typical fastener screw 520.

In one embodiment, the fastener extraction tool 400 contains the elastomer layer 120. In other embodiments, the fastener extraction tool 300 contains the elastomer layer 120 and adhesive layer 132. In yet another embodiment, the fastener extraction tool 200 contains the elastomer layer 120, adhesive layer 132, and backing layer 112. In yet another embodiment, the fastener extraction tool 100 contains the elastomer layer 120, adhesive layers 130 and 132, and backing layers 110 and 112.

The elastomer layer 120 can be made from an elastic polymeric substance that displays rubber-like elasticity. An elastomer with an ultimate elongation of between 700% and 800% has been found to be effective. An elastomer with a durometer of between 35 and 45 Shore A hardness has been found to be effective.

The adhesive layers 130 and 132 can be made from an adhesive formulated to bond to low surface energy materials such as natural and synthetic elastomers. An acrylic or rubber based adhesive has been found to be effective. The adhesive layers 130 and 132 may be formulated with more than one layer of adhesive each. When more than one adhesive is used for each adhesive layers 130 and 132, one or more carrier layers may also be used. Such carrier layers can be made from polyester films.

The backing layers 110 and 112 can be made from liners specifically made as liners for easy removal from adhesive and adhesive transfer tapes. Backing layer materials such as densified Kraft liners has been found to be effective.

The fastener extraction tool 400 can be placed between a fastener with a stripped head 525 and a driver 510. The elastomer layer 120 is deformed between the driver 510 and fastener head 525 when driving. The deformation and physical properties of the elastomer layer 120 aid in removing the fastener with a stripped head.

The fastener extraction tool 300 can be placed between a fastener with a stripped head 525 and a driver 510. The adhesive layer 132 is placed proximal to the fastener head to bond to it. Alternatively, the adhesive layer 132 can be placed proximal to the driver 510 to bond to it. The elastomer layer, 120 is deformed between the driver 510 and fastener head 525 when driving. The deformation and physical properties of the elastomer layer 120 and adhesive layer 132 aid in removing the fastener 520 with a stripped head 525.

The fastener extraction tool 200 can remove and discard the backing layer 112. The elastomer layer 120 with attached adhesive layer 132 is placed between a fastener 520 with a stripped head 525 and a driver 510. The adhesive layer 132 can be placed proximal to the fastener head 520 to bond to it. Alternatively, the adhesive layer 132 can be placed proximal to the drive 510 to bond to it. The elastomer layer, 120 is deformed between the driver 510 and fastener head 520 when driving. The deformation and physical properties of the elastomer layer 120 and adhesive layer 132 aid in removing the fastener with a stripped head 525.

The fastener extraction tool 100 can remove and discard the backing layers 110 and 112. The elastomer layer 120 with attached adhesive layers 130 and 132 is placed between a fastener with a stripped head 525 and a driver 510. The adhesive layer 130 or 132 can be placed proximal to the fastener head 525 to bond to it. Alternatively, the adhesive layer 130 or 132 can be placed proximal to the driver 510 to bond to it. The elastomer layer 120 is deformed between the driver 510 and fastener head 525 when driving. The deformation and physical properties of the elastomer layer 120 and adhesive layers 130 and 132 aid in removing the fastener 520 with a stripped head 525.

In a fastener extraction tool, the tool provides convenience to a user for extracting fasteners 520 with stripped heads 525 without needing to replace the driver 510 with a specialty driving bit. In one embodiment, the fastener extraction tool 500 is placed on the fastener head 525 with or without adhesive 130. Advantageously, the fastener extraction tool 500 elastomer layer 120 deforms between the driver 510 and fastener head 525 when driving and thus aids in extraction. An example is shown in FIGS. 15, 16, 17, 18, and 19. In addition, an apparatus implementing principles of the present disclosure will be capable of housing one or more tools for storage.

As various changes could be made in the above methods and compositions without departing from the scope of the present disclosure, it is intended that all matter contained in the above description and shown in the accompanying drawings shall be interpreted as illustrative and not in a limiting sense.

1. A fastener extraction tool, comprising:
an elastomer layer.

2. The fastener extraction tool of claim 1, further comprising an adhesive layer, attached to the elastomer layer.

3. The fastener extraction tool of claim 2, further comprising an adhesive layer wherein adhesive layers sandwich the elastomer layer.

4. The fastener extraction tool of claim 2, further comprising a backing layer in contact with the adhesive layer.

5. The fastener extraction tool of claim 3, further comprising backing layers in contact with the adhesive layers.

6. The fastener extraction tool of claim 1, wherein the layer material is an elastic polymer.

7. A method of placing a fastener extraction tool elastomer layer between a driver and fastener, driving the fastener for extraction.

8. The method of claim 7, placing a fastener extraction tool, wherein said fastener extraction tool includes the elastomer layer and an adhesive layer, between a driver and fastener, driving the fastener for extraction.

9. The method of claim 7, placing a fastener extraction tool, wherein said fastener extraction tool includes the adhesive layer, the elastomer layer, and an elastomer layer, said adhesive layers sandwiching the elastomer layer, between a driver and fastener, driving the fastener for extraction.
